(19) United States
(12) Patent Application Publication
(10) Pub. No.: US 2025/0383725 A1
(43) Pub. Date: Dec. 18, 2025

(54) HIM DEVICE SETTING METHOD AND HIM DEVICE OUTPUT ADJUSTING METHOD

(71) Applicant: PixArt Imaging Inc., Hsin-Chu City (TW)

(72) Inventors: Tse-Chung Su, Hsin-Chu City (TW); Tzung-Min Su, Hsin-Chu City (TW); Ming-Hung Tsai, Hsin-Chu City (TW); Tzu-Ching Wang, Hsin-Chu City (TW)

(73) Assignee: PixArt Imaging Inc., Hsin-Chu City (TW)

(21) Appl. No.: 18/740,549

(22) Filed: Jun. 12, 2024

(51) Int. Cl. G06F 3/0354; G06F 3/01; G06F 3/0362; G06F 3/041

(52) U.S. Cl. CPC G06F 3/03547; G06F 3/017; G06F 3/0362; G06F 3/04146

(57) ABSTRACT

A HIM device setting method is disclosed, which is applied to a HIM control device comprising a processing circuit. The HIM device setting method comprises: collecting input information of a HIM device by the processing circuit; and dynamically adjusting parameters of the HIM device according to the input information by the processing circuit. A corresponding HIM device output adjusting method is also disclosed. By this way, the output or the parameters of the HIM device may adjusted, to increase the user experience.

### BACKGROUND OF THE INVENTION

### 1. Field of the Invention

The present invention relates to a HIM (human machine interface) device setting method and a HIM device output adjusting method, and particularly relates to a HIM device setting method and a HIM device output adjusting method which can dynamically adjust parameters of the HIM device or the HIM device output according to input information from the HIM device.

### 2. Description of the Prior Art

HIM device is an interface which provides communication between a user and a device. For example, the HIM device is connected with a host device such as a computer, a user can provide user inputs to the HIM device, and the HIM device transforms the user inputs to signals or codes which the host device can identify. By this way, the host device can be controlled by the user.

The parameters of a conventional HIM device are always pre-set at the factory. Accordingly, the parameters of the conventional HIM device are always fixed. However, different users may have different habits or user behaviors, thus the initial pre-set parameters may not be most suitable for the user. Even if the user wants to reset the parameters by himself, the steps are always complicated or specific software is needed.

### SUMMARY OF THE INVENTION

One objective of the present invention is to provide a HIM device setting method which can increase user experience for the HIM device.

Another objective of the present invention is to provide a HIM device output adjusting method which can increase user experience for the HIM device.

One embodiment of the present invention discloses a HIM device setting method, applied to a HIM control device comprising a processing circuit, comprising: collecting input information of a HIM device by the processing circuit; and dynamically adjusting parameters of the HIM device according to the input information by the processing circuit.

Another embodiment of the present invention discloses a HIM device output adjusting method, comprising: collecting first input information of a HIM device by the processing circuit; and dynamically adjusting second input information of the HIM device according to the first input information by the processing circuit.

In view of above-mentioned embodiments, the output or the parameters of the HIM device may adjusted, to increase the user experience.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a HIM control device using the HIM device setting method provided by the present invention, according to one embodiment of the present invention.

FIG. 2, FIG. 3, FIG. 4 and FIG. 5 are schematic diagrams illustrating examples of the HIM device, according to embodiments of the present invention.

FIG. 6 is a block diagram illustrating a HIM control device using the HIM device setting method provided by the present invention, according to another embodiment of the present invention.

FIG. 7 is a schematic diagram of the operation of collecting input information, according to one embodiment of the present invention.

FIG. 8 is a schematic diagram illustrating detail steps of the embodiment illustrated in FIG. 7, according to one embodiment of the present invention.

FIG. 9 is a flow chart illustrating a HIM device setting method, according to one embodiment of the present invention.

FIG. 10 is a flow chart illustrating a HIM device output adjusting method, according to one embodiment of the present invention.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices.

FIG. 1 is a block diagram illustrating a HIM control device using the HIM device setting method provided by the present invention, according to one embodiment of the present invention. As shown in FIG. 1, the HIM control device 100 comprises a processing circuit 101, a buffer 103 and a storage device 105. The HIM control device 100 may be comprised in the HIM device HD or be independent from the HIM device HD. The processing circuit 101 collects input information IF of the HIM device HD. Besides, the processing circuit 101 dynamically adjusts parameters of the HIM device HD according to the input information IF. For example, the processing circuit 101 may generate a control signal CS to set the HIM device HD.

In one embodiment, the processing circuit 101 uses an AI (Artificial Intelligence Act) model to learn how to adjust parameters of the HIM device HD according to the input information IF, but is not limited. In one embodiment, the input information IF is stored in the buffer 103 when the HIM control device 100 is active, and the buffered input information IF is moved from the buffer 103 to the storage device 105 if the buffered input information IF is to be non-active. By this way, the input information IF can be kept and used by the AI model even if the HIM control device 100 is non-active.

In one embodiment, after the HIM control device 100 is active, the processing circuit 101 automatically collects the input information IF, with or without receiving any triggering signal provided by the user. Also, the processing circuit 101 dynamically and automatically adjusts parameters of the HIM device HD according to the input information IF, with or without receiving the triggering signal provided. Also, in one embodiment, the above-mentioned parameters of the HIM device HD are control parameters for detecting a user input which generates the input information. Detail descriptions of the input information, the user input and the control parameters will be described in following descriptions.

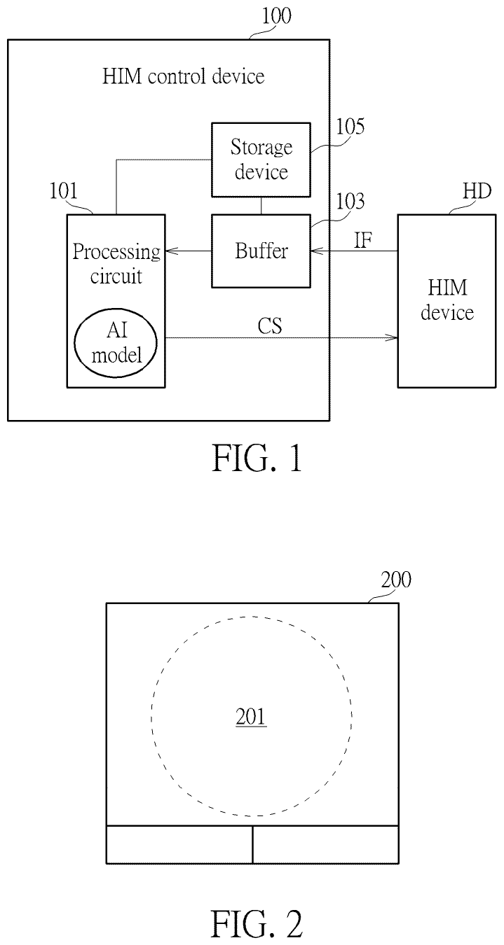

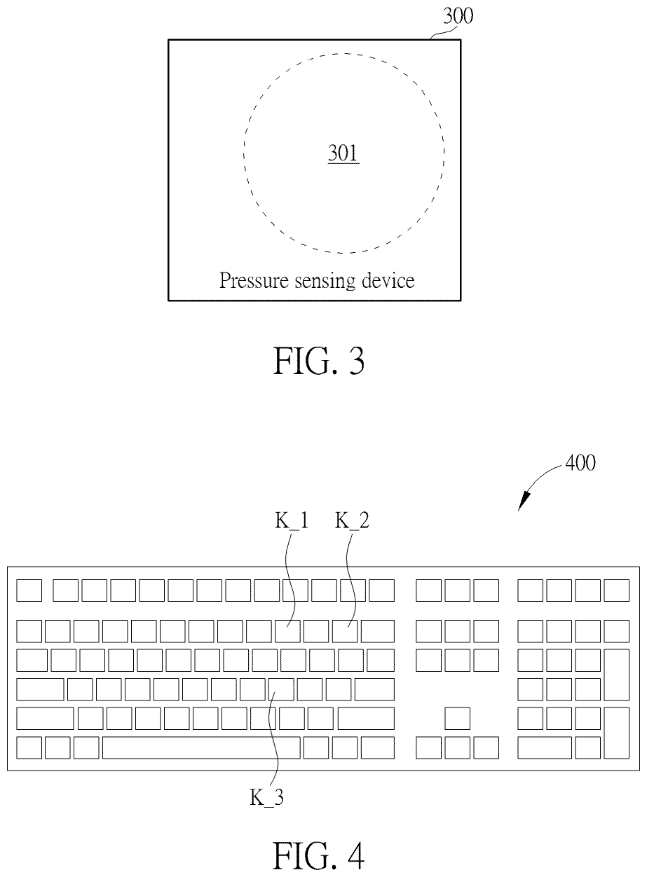

FIG. 2, FIG. 3, FIG. 4 and FIG. 5 are schematic diagrams illustrating examples of the HIM device, according to embodiments of the present invention. In the embodiment of FIG. 2, the HIM device HD is a touch sensing device 200, such as a touch pad. In such embodiment, the input information may comprise at least one of: a touch region size, a touch location, a touch time, a touch frequency, and a touch track. For example, if the user always touches the region 201 while using the touch sensing device 200, the processing circuit 101 may set the regions of the touch sensing device 200 besides the region 201 to be non-active or to have a lower touch sensing sensitivity (i.e., change the control parameters for detecting touch), to avoid accidental touch. In another example, if the touch frequency is low when the user uses the touch sensing device 200, the touch sensing sensitivity or the report rate of the touch sensing device 200 may be decreased.

Also, in the embodiment of FIG. 3, the HIM device HD is a force sensing device 300. In such embodiment, the input information comprises at least one of: a press force, a press location, a press time, and a press frequency. For example, if the user always presses the region 301 for force sensing and the press force is always in a specific range, the sensing sensitivity of the region 301 for forces falling within a specific range can be improved, to improve the force sensing accuracy.

Further, in the embodiment of FIG. 4, the HIM device HD comprises a plurality of buttons (or named keys), such as a keyboard 400. In such embodiment, the input information IF comprises at least one of: a number of the buttons which are triggered, a distribution of the buttons which are triggered, and a trigger time of the buttons which are triggered. For example, if the user always presses the keys K 1, K 2 and K 3 repeatedly and quickly, the frequency of outputting signals generated by these keys maybe may be increased. For another example, if the frequency of pressing keys is low when the user uses the keyboard 400, the frequency of outputting the signals generated by all keys may be decreased.

Besides, in the embodiment of FIG. 5, the HIM device HD is a navigation device 500 such as a mouse. In such embodiment, the input information may comprise at least one of: a moving direction detected by the HIM device HD and a moving distance detected by the HIM device HD. For example, if the moving frequency of the navigation device 500 is low when it is used, the report rate thereof may be set to be low. Please note, in the embodiment of FIG. 5, the navigation device 500 also comprises the buttons B 1, B 2, B 3, thus the rule stated in FIG. 4 may also be applied to the navigation device 500 shown in FIG. 5.

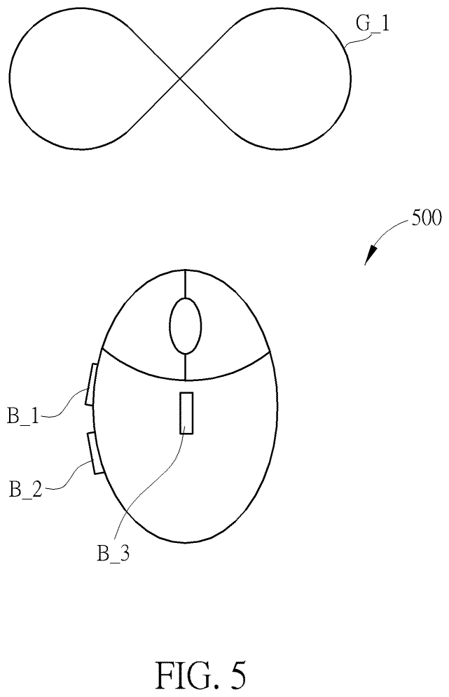

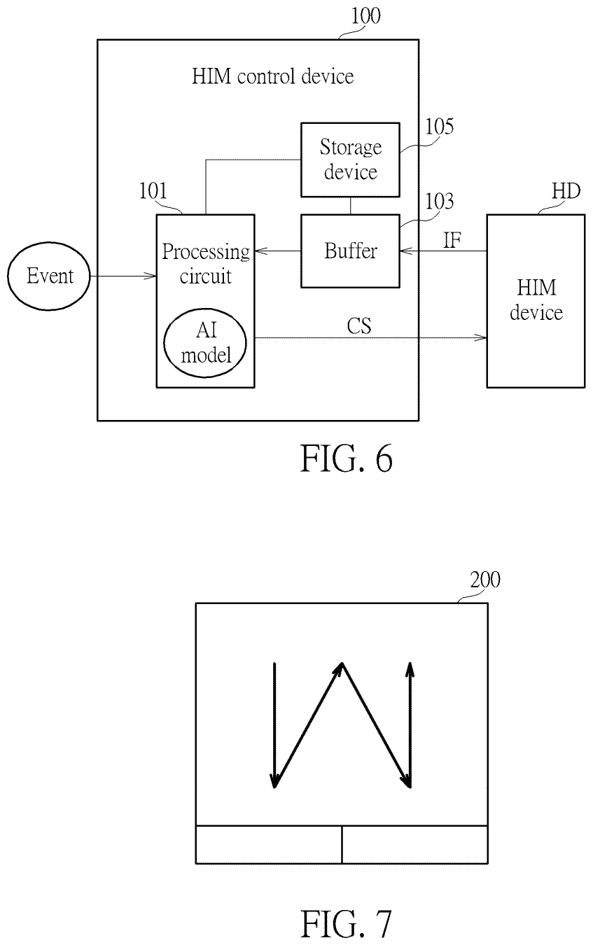

In one embodiment, the input of the HIM device HD may cause some events to a host device which the HIM device HD is connected with. The host device can be, for example, a computer. In such case, the processing circuit 101 further dynamically adjusts the parameters of the HIM device HD according to the event, as shown in FIG. 6. Please refer to FIG. 2 again. As above-mentioned, in one embodiment, the HIM device HD is the touch sensing device 200. In such case, the user may try tapping the touch sensing device 200 for several times in a short time to perform a double tap, to open a folder shown on the host device connected with the touch sensing device 200. The operation of “open a folder” is one example of the above-mentioned “event”. In such example, the frequency of outputting taps of the touch sensing device 200 may be adjusted to increase the success rates of identifying double taps. Such rule may also be applied to the embodiment shown in FIG. 3. For example, the user may press some regions of the force sensing device 300 in FIG. 3 to perform some gestures to control the host device to perform some functions. In such case, the parameters of outputting force sensing related with the gesture (e.g., the output frequency or force sensing sensitivity) may be adjusted to improve the success rates of identifying the gesture.

Please refer to FIG. 4 again. As above-mentioned, in such embodiment, the HIM device HD comprises a plurality of buttons, such as a keyboard 400. In such case, the event may be a macro performed by triggering at least one of the buttons. For example, if the user always presses keys K 1, K 2 and K 3 simultaneously to perform a pre-recorded macro. Such macro may correspond to a function of the host device connected with the keyboard 400. For example, the macro may mean opening a multimedia website on the host device. Accordingly, in such case, the parameters of outputting the pressing of the keys K 1, K 2 and K 3 may be adjusted to improve the success rate of performing the macro corresponding to the keys K 1, K 2 and K 3.

Please refer to FIG. 5 again. As above-mentioned, the HIM device HD may be a navigation device 500 such as a mouse. In such case, the event may be a function corresponding to a predetermined gesture performed by the navigation device 500. For example, if the user always performs a gesture G 1 shown in FIG. 5 by moving the navigation device 500, to control the host device to perform a specific operation, such as showing recorded images. In such example, the parameters of outputting data related with gesture of the navigation device 500 may be adjusted to increase the success rates of identifying such gesture. For example, if the navigation device 500 is an optical mouse, the frame rate thereof may be adjusted such that the movement thereof may be computed more accurately, thereby the gesture of the optical mouse may be more easily to be identified. In above-mentioned embodiments, the input information IF of the HIN device is collected by the AI model which learns to adjust the parameters of the HIM device HD according to the input information IF. In another embodiment, the AI model may further learn to control other functions according to the collected input information IF. FIG. 7 is a schematic diagram of the operation of collecting input information, according to one embodiment of the present invention. In the embodiment of FIG. 7, the user performs a gesture W, which is formed by 5 arrows, on the touch sensing device 200, to unlock a host device connected with the touch sensing device 200. In such case, the input information related the gesture W is collected, and parameters of unlocking the host device is adjusted according to the input information.

For more detail, the input information related the gesture W may be the above-mentioned parameters: the touch region size, the touch location, the touch time, and may also be the moving speed of the touch. In the next time of unlocking the host device, the host device is not unlocked even if a gesture W is performed on the touch sensing device 200. On the opposite, the host device is unlocked when the gesture W is performed on the touch sensing device 200 and the input information of the current gesture W meets the collected input information.

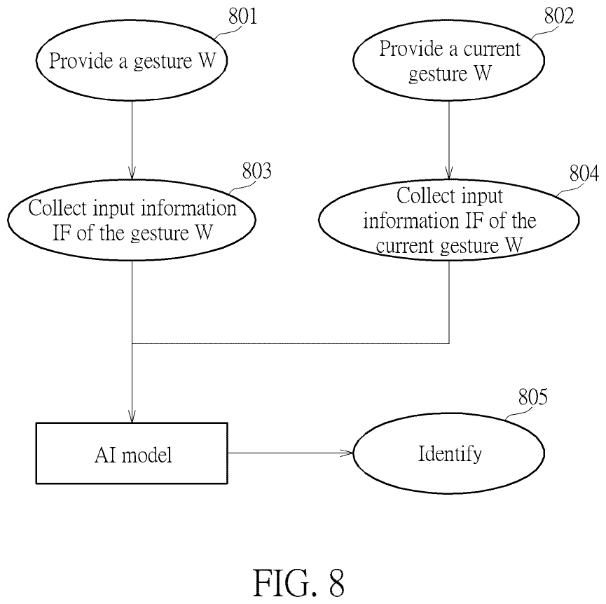

FIG. 8 is a schematic diagram illustrating detail steps of the embodiment illustrated in FIG. 7, according to one embodiment of the present invention. In FIG. 8, steps 801 and 803 correspond to a register state and steps 802, 804 corresponds to an application state. In the step 801, a user performs the gesture W shown in FIG. 7, which is to be registered, to the touch sensing device 200. After that, the input information IF related with the gesture W is collected in the step 803 and provided to the AI model for learning. In step 802, a current gesture W, which is to be identified, is provided to the touch sensing device 200. Next, in the step 804, the input information related with the current gesture W is and provided to the AI model for recognizing. In step 805, if the input information IF collected in the step 804 meets the input information IF collected in the step 803, the host device is unlocked. On the contrary, if the input information IF collected in the step 804 does not meet the input information IF collected in the step 803, the host device is not unlocked. Please note, the rules stated in FIG. 7 and FIG. 8 are not limited to gesture recognizing and host device unlocking.

The above-mentioned embodiments may set the parameters of the HIM device HD to different values corresponding to different users. For example, if the user is a first user, the parameters of the HIM device HD are set to a first value combination. If the user is a second user, the parameters of the HIM device HD are set to a second value combination.

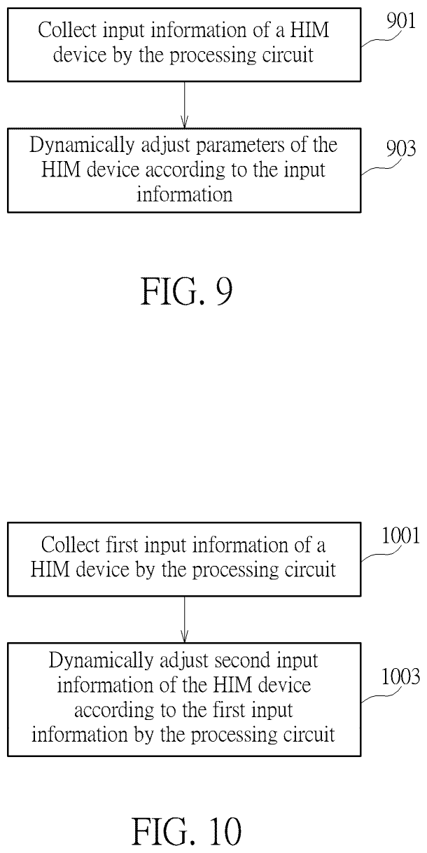

FIG. 9 is a flow chart illustrating a HIM device setting method, according to one embodiment of the present invention. The HIM device setting method is applied to a HIM control device comprising a processing circuit, such as the HIM control device 100 shown in FIG. 1 and FIG. 6. The HIM device setting method comprises:

### Step 901

Collect input information of a HIM device by the processing circuit.

### Step 903

Dynamically adjust parameters of the HIM device according to the input information.

In above-mentioned embodiments, the parameters of the HIM device HD are set according to the input information, to improve the user experience for the HIM device HD. However, such effect may also be reached via adjusting the current input information output by the HIM device HD according to the collected input information, by the processing circuit 101. Take the embodiment of FIG. 2 for example, as above-mentioned, the frequency of outputting taps of the touch sensing device 200 is adjusted to increase the success rates of identifying taps. In such example, the processing circuit 101 may add a dummy time interval to the initial time intervals between two received continuous taps, to reach the same effect. For another example, in FIG. 3, some force sensing regions are non-active. In such case, the force sensing signals from these force sensing regions may be ignored by the processing circuit 101.

For still another example, in the embodiment of FIG. 5, if the user always performs a gesture G 1 shown in FIG. 5 by moving the navigation device 500, to control the host device to perform a specific operation, such as showing recorded images. In such example, the parameters of identifying such gesture of the navigation device 500 may be adjusted by the processing circuit 101 to increase the success rates of identifying such gesture. For example, the movements output by the navigation device 500 can be calibrated so that the movements are more easily identified as forming the gesture G 1. Other examples shown in FIG. 2, FIG. 3, FIG. 4 and FIG. 5 may also be varied following the rules depicted in above-mentioned examples.

In view of the above-mentioned examples, a HIM device output adjusting method can be acquired. FIG. 10 is a flow chart illustrating a HIM device output adjusting method according to one embodiment of the present invention, which comprises following steps:

### Step 1001

Collect first input information of a HIM device by the processing circuit.

### Step 1003

Dynamically adjust second input information of the HIM device according to the first input information by the processing circuit.

The first input information may be regarded as reference input information and the second input information may be regarded as current input information. Other detail steps can be acquired in view of the embodiments stated in FIG. 1-FIG. 9, thus are omitted for brevity here.

The above-mentioned embodiments may adjust the second input information to different values corresponding to different users. For example, if the user is a first user, the second input information is set to a first value. For another example, if the user is a second user, the second input information is set to a second value.

In view of above-mentioned embodiments, the output or the parameters of the HIM device may adjusted, to increase the user experience.

Those skilled in the art will readily observe that numerous modifications and alterations of the device and method may be made while retaining the teachings of the invention. Accordingly, the above disclosure should be construed as limited only by the metes and bounds of the appended claims.

1-10. (canceled)

11. A HIM device output adjusting method, comprising:
collecting first input information of a HIM device by the processing circuit; and
dynamically adjusting second input information of the HIM device according to the first input information by the processing circuit.

12. The HIM device output adjusting method of claim 11, wherein the HIM device is a touch sensing device, and the first input information, the second input information comprise at least one of: a touch region size, a touch location, a touch time, a touch frequency, and a touch track.

13-15. (canceled)

16. The HIM device output adjusting method of claim 11, further comprising:
collecting an event caused by an input received by the HIM device by the processing circuit; and
dynamically adjusting the second input information according to the event.

17. The HIM device output adjusting method of claim 16, wherein the HIM device is a touch sensing device, and the event is a function corresponding to a predetermined gesture.

18-19. (canceled)
